(19) United States
(12) Patent Application Publication
(10) Pub. No.: US 2020/0309998 A1
(43) Pub. Date: Oct. 1, 2020

(54) DISPLAY DEVICE WITH TOUCH SCREEN FUNCTION

(71) Applicant: FUTABA CORPORATION, Mobara-shi (JP)

(72) Inventors: Mao SHISEKI, Mobara-shi (JP); Takayoshi YOSHIDA, Mobara-shi (JP); Yasuyuki NAITO, Mobara-shi (JP)

(21) Appl. No.: 16/817,685

(22) Filed: Mar. 13, 2020

(30) Foreign Application Priority Data
Mar. 27, 2019 (JP) 2019-060563

(51) Int. Cl. G02B 1/118; G02F 1/1335; G06F 3/041

(52) U.S. Cl. CPC G02B 1/118; G06F 3/041; G02F 1/133502

(57) ABSTRACT

A display device having touch screen function is provided. The display device includes a display panel, a curved touch panel, a holding unit and an anti-reflection film. The holding unit is configured to hold the display panel and the touch panel such that the display panel and the touch panel face each other through an air gap. The anti-reflection film is formed on one of a surface of the display panel and a surface of the touch panel that face each other.

### TECHNICAL FIELD

The present disclosure relates to a display device with a touch screen function, in which a touch panel is attached to a display panel such as a liquid crystal display or the like.

### BACKGROUND

Conventionally, a display device such as the device disclosed in Japanese Patent Application Publication No. 2017-54068 is known as a display device with a touch screen function, in which the touch panel is attached to the display panel such as a liquid crystal display device.

The display device disclosed in Japanese Patent Application Publication No. 2017-54068 employs an air gap structure in which a flat liquid crystal panel and a flat touch panel are held to face each other through an air gap.

In the case of attaching the above-described display device to vehicles, it is required to consider the design and operability when providing the device. For example, is the case of mounting and installing a display device having a touch screen function as an operation panel to a centered information display (CID) of a vehicle such as a dashboard, an instrument's periphery, an air conditioner or a car navigation system, an instrument panel, or an auxiliary display, it is required to provide a touch panel that is curved to correspond to a shape of a mounting portion such as the dashboard, instead of the flat touch panel disclosed in Japanese Patent Application Publication No. 2017-54068, to prevent impairs of the design and operability. In that case, a display device having a touch screen function that can realize low reflection even with a curved touch panel is required. In addition, when the curved touch panel and the display panel are held to face each other through an air gap, the distance between the curved touch panel and the display panel varies depending on the location. Therefore, it is necessary to stably install the touch panel and the display panel while maintaining the air gap.

In view of the above, the present disclosure provides a display device with a touch screen function that is stably installed and can realize low reflection even with a curved touch panel.

### SUMMARY

In accordance with an aspect of the present disclosure, there is provided a display device with a touch screen function, including: a display panel; a curved touch panel; a holding unit configured to hold the display panel and the touch panel such that the display panel and the touch panel face each other through an air gap; and an anti-reflection film formed on at least one of a surface of the display panel and a surface of the touch panel that face each other.

Further, the holding unit may include an accommodating member that accommodates the display panel, and an attachment member having a base end portion that is attached to an outer peripheral portion of the accommodating member while protruding upward to be closer to the touch panel over a display surface of the display panel and an attachment end portion that is attached to an outer peripheral edge of an inner surface of the touch panel while having a shape corresponding to a shape of the inner surface of the touch panel.

Further, the holding unit may accommodate the display panel and may be attached to an outer peripheral edge of an inner surface of the touch panel while having a shape corresponding to a shape of the inner surface of the touch panel.

Further, the anti-reflection film may be a moth-eye film.

In accordance with the aspect of the present disclosure, the anti-reflection film is formed on at least one of the surface of the display panel and the surface of the curved touch panel facing each other, so that the low reflection can be realized even when the curved touch panel is used. Further, the display panel and the curved touch panel can be stably installed to face each other through the air gap by the holding unit that accommodates the display panel and has a shape corresponding to a shape of the inner surface of the touch panel.

### BRIEF DESCRIPTION OF THE DRAWINGS

The objects and features of the present disclosure will become apparent from the following description of embodiments, given in conjunction with the accompanying drawings, in which:

FIG. 1 is a schematic perspective view showing an appearance of a display device having a touch screen function according to a first embodiment of the present disclosure;

FIGS. 2A and 2B are cross-sectional views taken along a line A-A and a line B-B in FIG. 1, respectively, and FIG. 2C is an enlarged cross-sectional view of FIG. 2A;

FIG. 3 is a schematic perspective view showing an appearance of a display device having touch screen function according to a second embodiment of the present disclosure; and

FIGS. 4A and 4B are cross-sectional views taken along a line C-C and a line D-D in FIG. 3, respectively, and FIG. 4C is an enlarged cross-sectional view of FIG. 4A.

### DETAILED DESCRIPTION

Hereinafter, embodiments of the present invention will be described in detail with reference to the accompanying drawings.

In order to realize a display device with touch screen function that can be mounted as an operation panel for vehicles without impairing design and operability of a dashboard or the like of a vehicle, OCR direct bonding using an optical adhesive may be considered as a method for bonding a display panel and a curved touch panel.

However, OCR direct bonding is disadvantageous in that it is difficult to manage the treatment such as filling or drying of materials. In addition, the amount of filling materials required for filling the space between the display panel and the curved touch panel without a gap increases, so the material cost also increases.

Further, the display surface of the display panel is distorted depending on the direction of the curved surface of the touch panel. For example, when the surface on the user side is convex, the display surface of the display panel is distorted due to the effect of the convex lens.

Further, OCR direct bonding is disadvantageous in that once the display panel and the curved touch panel are adhered to each other, it is difficult to separate them and, thus, the reworkability is poor.

Therefore, the present disclosure provides a display with a touch screen function and an air gap structure that allows stable installation to solve the above-described drawbacks even in the case of using a curved touch panel while realizing low reflection.

### First Embodiment

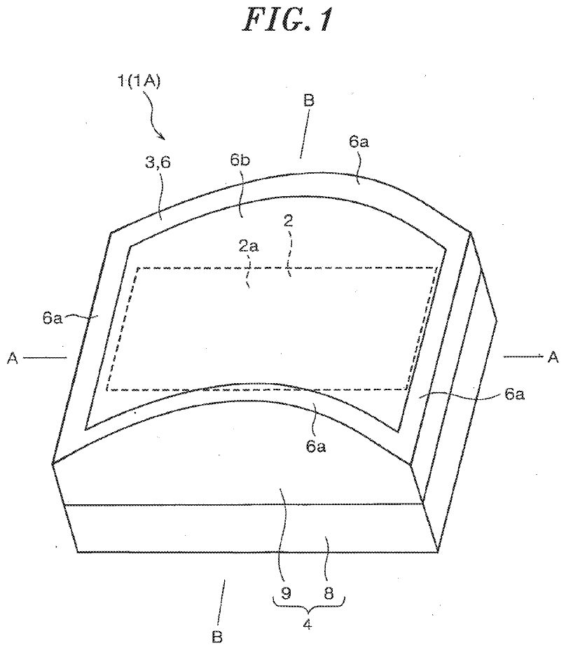

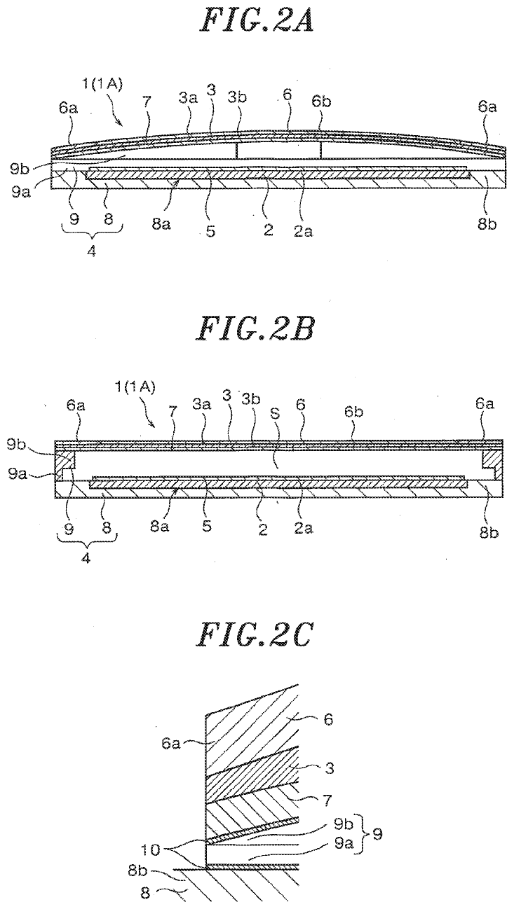

A configuration of a display device having a touch screen function according to a first embodiment will be described with reference to FIGS. 1 and 2A to 2C. In FIG. 1, the thickness of the touch panel and the thickness of a decorative cover are not illustrated.

As shown in FIGS. 2A and 2B, the display device 1 (1A) with touch screen function according to the first embodiment includes a display panel 2, a touch panel 3, and a holding unit 4. The display device 1 (1A) has an air gap structure in which the display panel 2 and the touch panel 3 are held by the holding unit 4 to face each other with an air gap (air layer) S therebetween.

As shown in FIG. 1 and FIGS. 2A and 2B, the display panel 2 is a rectangular liquid crystal display having fiat display surface (inner surface) 2a and is held by the holding unit 4 to face the touch panel 3 through the air gap S. The display surface 2a of the display panel 2 is not limited to the flat shape as shown in FIG. 1 and FIGS. 2A and 2B, and the display surface 2a may have a curved shape.

As shown in FIGS. 2A and 2B, an anti-reflection film 5 such as a moth-eye film or an anti-reflective (AR) film is formed in close contact with (formed on and attached to) the display surface 2a of the display panel 2. The anti-reflection film 5 minimizes reflection of light on the display surface 2a. Particularly, when the display panel 2 has an anti-glare (non-gloss) function that scatters light, a moth-eye film or an AR film serving as the anti-reflection film 5 makes the display clear without blurring.

The touch panel 3 is an input device made of glass or resin. A user touches an operation surface (outer surface) 3a positioned above a menu screen displayed on the display surface 2a of the display panel 2 with a finger.

As shown in FIG. 1, the touch panel 3 is convex with a predetermined curvature to form an outwardly (upwardly) curved surface that is convex from the center that is the highest position on the cross-section taken along the line A-A (see FIG. 2A) toward lines at both ends that are parallel with the line B-B. The touch panel 3 is held by the holding unit 4 to face the display panel 2 through the air gap S.

A rectangular decorative cover 6 made of, e.g., glass or resin, is integrally disposed on the operation surface 3a of the touch panel 3 to form one unit. As shown in FIG. 1 and FIGS. 2A to 2C, the decorative cover 6 is entirely convex to correspond to the shape of the outer surface of the touch panel 3.

The outer peripheral portion of the decorative cover 6 forms, for example, a frame-shaped black decorative portion 6a having a shielding property, so that the inside thereof cannot be observed. The inner portion of the decorative portion 6a of the decorative cover 6 forms a transparent portion 6b to face the display surface 2a of the display panel 2, so that the menu screen on the display surface 2a can be observed therethrough.

As shown in FIGS. 2A and 2B, an anti-reflection film 7 such as a moth-eye film or an AR film is formed in close contact with an inner surface 3b opposite to the operation surface 3a of the touch panel 3. The anti-reflection film 7 prevents internal reflection and provides a clear visual of the display surface 2a of the display panel 2.

The holding unit 4 holds the display panel 2 and the touch panel 3 to face each other through the air gap S. The holding unit 4 includes an accommodating member 8 and an attachment member 9.

As shown in FIGS. 2A and 2B, the accommodating member 8 has a rectangular recess 8a that is cut out to fit to the outer shape of the display panel 2. The display panel 2 is accommodated in the recess 8a such that the display surface 2a faces the inner surface 3b of the touch panel 3. Further, the outer peripheral portion surrounding the recess 8a forms a rectangular frame-shaped portion 8b.

The attachment member 9 is disposed on the accommodating member 8 to attach the touch panel 3. As shown in FIGS. 2A and 2C, the attachment member 9 has a base end portion 9a and an attachment end portion 9b.

As shown in FIG. 2A, the base end portion 9a protrudes upward (outward) to be closer to the touch panel 3 over the display surface 2a of the display panel 2. The base end portion 9a has a frame shape to correspond to the frame-shaped portion 8b of the accommodating member 8. As shown in FIG. 2C, the base end portion 9a is attached to the frame-shaped portion 8b of the accommodating member 8 via an adhesive 10 such as a double-sided tape or an adhesive agent.

The attachment end portion 9b is formed on each of the opposite inner wall surfaces of the base end portion 9a, the opposite inner wall surfaces being parallel to the line A-A of FIG. 1. As shown in FIGS. 2A and 2C, the surface of the attachment end portion 9b that faces the inner surface 3b of the touch panel 3 has a shape corresponding to the shape of the inner surface 3b of the touch panel 3. In the present embodiment, the inner surface 3b of the touch panel 3 has a convex shape, so the surface of the attachment end portion 9b that faces the inner surface 3b of the touch panel 3 also has a convex shape. As shown in FIGS. 2A and 2C, the attachment end portion 9b is attached to each of the opposite outer peripheral edges of the inner surface 3b of the touch panel 3, the opposite outer peripheral edges being parallel to the line A-A of FIG. 1, via the adhesive 10 such as a double sided-tape or an adhesive agent.

As an example of the attachment member 9, it is also possible to use, e.g., an elastic member such as a sponge or the like. The elastic member serving as the attachment member 9 can conform to a shape corresponding to the shape of the inner surface 3b of the touch panel 3. The elastic member has one end adhered to the frame-shaped portion 8b of the accommodating member 8 via the adhesive 10 and the other end adhered in close contact with the outer peripheral edge of the inner surface 3b of the touch panel 3 via the adhesive 10.

In the above-described first embodiment, the case where the anti-reflection films 5 and 7 are formed on the inner surface (the display surface 2a) of the display panel 2 and the inner surface 3b of the touch panel 3 has been described as an example. However, the anti-reflection film may be formed on only one of the inner surface (the display surface 2a) of the display panel 2 and the inner surface 3b of the touch panel 3.

Further, in the above-described first embodiment, the attachment member 9 is formed as one unit in which the attachment end portion 9b is formed on each of the opposite inner wall surfaces of the frame-shaped base end portion 9a, the opposite inner wall surfaces being parallel to the line A-A. However, the present disclosure is not limited thereto.

For example, two attachment members 9 each having a plate-shaped base end portion 9a are provided, and each of the two attachment members 9 is structured such that the attachment end portion 9b is formed on the inner wall surface of the plate-shaped base end portion 9a. Then, the two attachment members 9 may be separately attached to the opposite outer peripheral edges of the inner surface 3b of the touch panel 3, the opposite outer peripheral edges being parallel to the line A-A. As another example, the attachment end portion 9b of the attachment member 9 may have a shape corresponding to a shape of the entire outer peripheral edge of the inner surface 3b of the touch. panel 3 and the entire outer peripheral edge of the inner surface 3b of the touch panel 3 may be attached to the attachment end portion 9b of the attachment member 9. Alternatively, the attachment end portion(s) 9b of the attachment member 9 may have a shape(s) corresponding to the shapes of the outer peripheral edges at multiple positions on the inner surface 3b of the touch panel 3, and the outer peripheral edges of the inner surface 3b of the touch panel 3 may be attached to the attachment end portion(s) 9b of the attachment member 9.

In other words, the attachment end portion 9b of the attachment member 9 may have a shape corresponding to the shape of the inner surface 3b of the touch panel 3 and may be attached to the outer peripheral edge(s) of the inner surface 3b of the touch panel 3.

### Second Embodiment

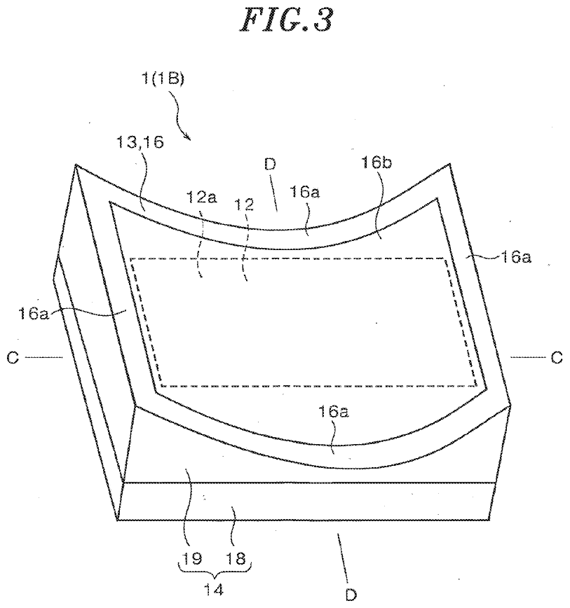

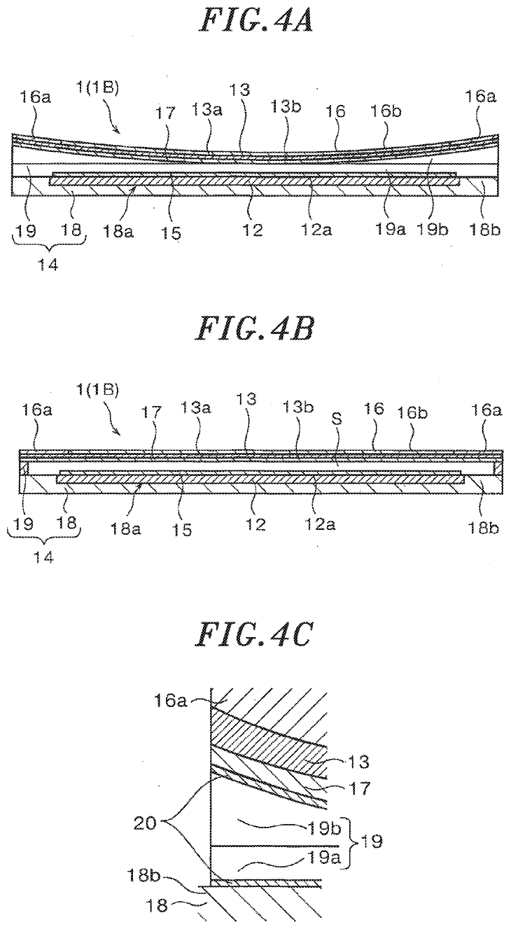

A configuration of a display device having a touch screen function according to a second embodiment will be described with reference to FIGS. 3 and 4A to 4C. In FIG. 3, the thickness of a touch panel and the thickness of a decorative cover are not illustrated.

As shown in FIGS. 4A and 4B, a display device 1 (1B) with a touch screen function according to the second embodiment includes a display panel 12, a touch panel 13, and a holding unit 14. The display device 1 (1B) has an air gap structure formed as one unit in which the display panel 12 and the touch panel 13 are held by the holding unit 14 to face each other with an air gap (air layer) S.

As shown in FIG. 3 and FIGS. 4A and 4B, the display panel 12 includes a rectangular liquid crystal display having a flat display surface (inner surface) 12a and is held by the holding unit 14 to face the touch panel 13 through the air gap S. The display surface 12a of the display panel 12 is not limited to the flat shape as shown in FIG. 3 and FIGS. 4A and 4B and may have a curved shape.

As shown in FIGS. 4A and 4B, an anti-reflection film 15 such as a moth-eye film or an AR film is formed in close contact with (formed on and attached to) the display surface 12a of the display panel 12. The anti-reflection film 15 minimizes reflection of light on the display surface 12a. Particularly, when the display panel 12 has an anti-glare (non-gloss) function that scatters light, a moth-eye film or an AR film serving as the anti-reflection film 15 makes the display clear without blurring.

The touch panel 13 is an input device made of glass or resin. A user touches an operation surface (outer surface) 13a positioned above a menu screen displayed on the display surface 12a of the display panel 12 with a finger.

As shown in FIG. 3, the touch panel 13 is concave with a predetermined curvature to form an inwardly (downwardly) curved surface that is concave from the center that is the lowest position on the cross-section taken along the line C-C (see FIG. 4A) toward lines at both ends that are parallel with the Line D-D. The touch panel 13 is held by the holding unit 14 to face the display panel 12 through the air gap S.

A rectangular decorative cover 16 made of, e.g., glass or resin, is integrally disposed on the operation surface 13a of the touch panel 13 to form one unit. As shown in FIG. 3 and FIGS. 4A to 4C, the decorative cover 16 is entirely concave to correspond to the shape of the outer surface of the touch panel 13.

The outer peripheral portion of the decorative cover 16 forms, for example, a frame-shaped black decorative portion 16a having a shielding property, so that the inside thereof cannot be observed. The inner portion of the decorative portion 16a of the decorative cover 16 forms a transparent portion 16b to face the display surface 12a of the display panel 12, so that the menu screen on the display surface 12a can be observed therethrough.

As shown in FIGS. 4A and 4B, an anti-reflection film 17 such as a moth-eye film or an AR film is formed in close contact with the inner surface 13b opposite to the operation surface 13a of the touch panel 13. The anti-reflection film 17 prevents internal reflection and provides a clear visual of the display surface 12a of the display panel 12.

The holding unit 14 holds the display panel 12 and the touch. panel 13 to face each other through the air gap S. The holding unit 14 includes an accommodating member 18 and an attachment member 19.

As shown in FIGS. 4A and 4B, the accommodating member 18 has a rectangular recess 18a that is cut out to fit to the outer shape of the display panel 12. The display panel 12 is accommodated in the recess 18a such that the display surface 12a faces the inner surface 13b of the touch panel 13. Further, the outer peripheral portion surrounding the recess 18a forms a rectangular frame-shaped portion 18b.

The attachment member 19 is disposed on the accommodating member 18 to attach the touch panel 13. As shown in FIG. 4C, the attachment member 19 includes a base end portion 19a and an attachment end portion 19b.

As shown in FIG. 4A, the base end portion 19a protrudes upward to be closer to the touch panel 13 over the display surface 12a of the display panel 12. The base end portion 19a is formed in a frame shape to correspond to the frame-shaped portion 18b of the accommodating member 18. As shown in FIG. 4C, the base end portion 19a is attached to the frame-shaped portion 18b of the accommodating member 18 via an adhesive 20 such as a double-sided tape or an adhesive agent.

The attachment end portion 19b is formed on each of the opposite inner wall surfaces of the base end portion 19a, the opposite inner wail surfaces being parallel to the line C-C of FIG. 3. As shown in FIGS. 4A and 4C, the surface of the attachment end portion 19b that faces the inner surface 13b of the touch panel 13 has a shape corresponding to the shape of the inner surface 13b of the touch panel 13. In the present embodiment, the inner surface 13b of the touch panel 13 has a concave shape, so the surface of the attachment end portion 19b that faces the inner surface 13b of the touch panel 13 also has a concave shape. As shown in FIGS. 4A and 4C, the attachment end portion 19b is attached to each of the opposite outer peripheral edges of the inner surface 13b of the touch panel 13, the opposite outer peripheral edges being parallel to the line C-C of in FIG. 3, via the adhesive 20 such as a double-sided tape or an adhesive agent.

As an example of the attachment member 19, it is also possible to use, e.g., an elastic member such as a sponge or the like. The elastic member serving as the attachment member 19 can conform to a shape corresponding to the shape of the inner surface 13b of the touch panel 13. The elastic member has one end adhered to the frame-shaped portion 18b of the accommodating member 18 via the adhesive 20 and the other end adhered in close contact with the outer peripheral edge of the inner surface 13b of the touch panel 13 via the adhesive 20.

In the above-described second embodiment, the case where the anti-reflection films are formed on the inner surface (the display surface 12a) of the display panel 12 and the inner surface 13b of the touch panel 13 has been described as an example. However, the anti-reflection film may be formed on only one of the inner surface (the display surface 12a) of the d splay panel 12 and the inner surface 13b of the touch panel 13.

Further, in the above-described second embodiment, the attachment member 19 is formed as one unit in which the attachment end portion 19b is formed on each of the opposite inner wall surfaces of the frame-shaped base end portion 19a, the opposite inner wall surfaces being parallel to the line C-C. However, the present disclosure is not limited thereto.

For example, two the attachment members 19 each having a plate-shaped base end portion 9a are provided, and each of the two attachment members 19 is structured such that the attachment end portion 19b is formed on the inner wall surface of a plate-shaped base end portion 19a. Then, the two attachment members 19 may be separately attached to the opposite outer peripheral edges of the inner surface 13b of the touch panel 13, the opposite outer peripheral edges being parallel to the line C-C. As another example, the attachment end portion 19b of the attachment member 19 may have a shape corresponding to the shape of the entire outer peripheral edge of the inner surface 13b of the touch panel 13, and the entire outer peripheral edge of the inner surface 13b of the touch panel 13 may be attached to the attachment end portion 19b of the attachment member 19. Alternatively, the attachment end portion(s) 19b of the attachment member 19 may have a shape(s) corresponding to the shapes of the outer peripheral edges at multiple positions on the inner surface 13b of the touch panel 13, and the outer peripheral edges of the inner surface 13b of the touch panel 13 may be attached to the attachment end portion(s) 19b of the attachment member 19.

In other words, the attachment end port on 19b of the attachment portion 19 may have a shape corresponding to the shape of the inner surface 13b of the touch panel 13 and may be attached to the outer peripheral edge(s) of the inner surface 13b of the touch panel 13.

In the above-described embodiments, the entirely convex touch panel 3 and the entirely concave touch panel 13 have been described as examples of the curved touch panel. However, the present disclosure is not limited thereto. In other words, at least a part of the touch panel may have the curved shape. For example, a touch panel may be partially convex or concave. Alternatively, a touch panel may have a concave shape and a convex shape that are randomly continued. Further, alternatively, a touch panel may have a concave shape and a convex shape that are randomly arranged at predetermined intervals.

In the above-described embodiments, the accommodating members 8 and 18 and the attachment members 9 and 19 are formed as separate members. However, the accommodating member 8 and the attachment member 9 are formed as one unit to constitute the holding unit 4, and/or the accommodating member 18 and the attachment member 19 are formed as one unit to constitute the holding unit 14.

As described above, in the present embodiment, the air gap structure formed as one unit is employed in such a manner that the display panel 2 (12) and the curved touch panel 3 (13) face each other through the air gap (air layer) S while being held by the holding unit 4 (14). Therefore, unlike the case of OCR direct bonding, display distortion on the display panels 2 and 12 due to the effect of the convex lens does not occur. In addition, it is possible to prevent the display surfaces 2a and 12a of the display panels 2 and 12 from being distorted due to direct force applied to the display surfaces 2a and 12a during touch operation.

Further, since the anti-reflection films 5, 7, 15, and such as moth-eye films or AR films are formed on the display surfaces 2a and 12a of the display panels 2 and 12 and/or on the inner surfaces 3b and 13b of the touch panels 3 and 13, it is possible to realize low reflection similar to that in OCR direct bonding. Particularly, if the moth-eye film is used as the anti-reflection films 5, 7, 15 and 17, the angle dependency can be reduced compared to the AR film.

Further, since the holding units 4 and 14 accommodate the display panels 2 and 12 and are attached to the outer peripheral edges of the inner surfaces 3b and 13b of the touch panels 3 and 13, respectively, while the holding units 4 and 14 have shapes respectively corresponding to the shapes of the inner surfaces 3b and 13b of the touch panels 3 and 13, unlike the case of OCR direct bonding, it is not necessary to manage the treatment such as tilling or drying of an optical adhesive and the stable installation can be easily performed at a low cost.

Further, since the touch panels 3 and 13 are respectively adhered to and held by the holding units 4 and 14 via the adhesive (double-sided tape or adhesive agent) 10, the reworkability can be improved compared to OCR direct bonding. Particularly, in the case of using a double-sided tape as the adhesive 10, even if the adhesion position of the touch panels 3 and 13 with respect to the holding units 4 and 14 are misaligned, the double-sided tape can be simply peeled off to adhere the touch panels 3 and 13 to the holding units 4 and 14 again.

For example, by using the touch panels 3 and 13 that are curved to correspond to a shape of a mounting portion of a vehicle, a display device having a low reflection touch screen function can be mounted and installed to a vehicle without impairing the design and operability. The mounting portion of the vehicle where the display device with the touch screen function is employed may include, e.g., a center information display (CID) including a dashboard, an instrument's periphery, an air conditioner or car navigation, an instrument panel, an auxiliary display, or the like.

While the embodiments of the display device with touch screen function of the present disclosure have been described, the present disclosure is not limited thereto. Other embodiments, examples, and operation techniques made by those skilled in the art based on the above-described embodiment are included in the scope of the present disclosure.

1. A display device with touch screen function, comprising:
a display panel;
a curved touch panel;
a holding unit configured to hold the display panel and the touch panel such that the display panel and the touch panel face each other through an air gap; and
an anti-reflection film formed on at least one of a surface of the display panel and a surface of the touch panel that face each other.

2. The display device of claim 1, wherein the holding unit includes:
an accommodating member that accommodates the display panel; and
an attachment member having a base end portion that is attached to an outer peripheral portion of the accommodating member while protruding upward to be closer to the touch panel over a display surface of the display panel and an attachment end portion that is attached to an outer peripheral edge of an inner surface of the touch panel while having a shape corresponding to a shape of the inner surface of the touch panel.

3. The display device of claim 1, wherein the holding unit accommodates the display panel and is attached to an outer peripheral edge of an inner surface of the touch panel while having a shape corresponding to a shape of the inner surface of the touch panel.

4. The display device of claim 1, wherein the anti-reflection film is a moth-eye film.

5. The display device of claim 2, wherein the anti-reflection film is a moth-eye film.

6. The display device of claim 3, wherein the anti-reflection film is a moth-eye film.
